(19) United States
(12) Patent Application Publication
(10) Pub. No.: US 2008/0212599 A1
(43) Pub. Date: Sep. 4, 2008

(54) METHODS AND SYSTEMS FOR ENCODING DATA IN A COMMUNICATION NETWORK

(75) Inventors: Peisong Chen, San Diego, CA (US); Qiang Gao, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/739,076

(22) Filed: Apr. 23, 2007

Related U.S. Application Data
(60) Provisional application No. 60/892,518, filed on Mar. 1, 2007.

(51) Int. Cl. H04L 12/28

(52) U.S. Cl. 370/411; 370/252

(57) ABSTRACT

Methods and systems for encoding data in a communication network are presented. In an aspect, a method is provided for processing multimedia data. The method includes detecting a smoothness factor associated with one or more portions of the multimedia data, and determining that smoothing is required based on the smoothness factor. The method also includes moving selected multimedia data from a first selected portion of the multimedia data to a second selected portion of the multimedia data, wherein the smoothness factor is adjusted. In an aspect, an apparatus is provided that includes a detector configured to detect a smoothness factor associated with one or more portions of the multimedia data, and to determine that smoothing is required based on the smoothness factor. The apparatus also includes an encoder configured to move selected multimedia data from a first selected portion of the multimedia data to a second selected portion of the multimedia data.

### CLAIM OF PRIORITY

The present Application for Patent claims priority to Provisional Patent Application No. 60/892,518 entitled “Method and Apparatus for Bit Rate Smoothing Across Time and Layers” filed Mar. 1, 2007, and assigned to the assignee hereof and fully incorporated herein by reference for all purposes.

### BACKGROUND

1. Field

The present application relates generally to multimedia signal processing and, more particularly, to video encoding and decoding methods and systems.

2. Background

Data networks, such as wireless communication networks, have to trade off between services customized for a single terminal and services provided to a large number of terminals. For example, the distribution of multimedia content to a large number of resource limited portable devices (e.g., subscribers, users, handsets, etc.) is a complicated problem. Therefore, it is very important for network administrators, content retailers, and service providers to have a way to distribute content and/or other network services in a fast and efficient manner and in such a way as to increase bandwidth utilization and power efficiency.

In current content delivery/media distribution systems, multimedia content is packed into transmission superframes for communication over a distribution network. Each superframe can be packed with enough video frames to produce a presentation of predetermined time duration at a receiving device. As the superframes are received, a receiving device operates to concatenate the received video frames into a video frame stream that is decoded to render a video presentation.

Unfortunately, any particular superframe may contain more or less data than subsequent superframes. As a result, a stream of superframes conveying the multimedia content may exhibit a “burstiness” or bit-rate “variability” characteristic that indicates a fluctuating bit-rate from superframe to superframe. Such burstiness may affect the performance of a receiving device in an undesirable way.

Therefore, what is needed is a way to smooth the burstiness and/or bit-rate variability of transmitted multimedia data across time and/or layers.

### SUMMARY

In one or more aspects, a smoothing system, comprising methods and apparatus, is provided to smooth transmitted multimedia data. For example, the smoothing system operates to smooth the burstiness and/or bit-rate variability of transmitted multimedia data across time and/or layers

In certain aspects, a method is provided for processing multimedia data. The method can comprise one or more of detecting a smoothness factor associated with one or more portions of the multimedia data, and determining that smoothing is required based on the smoothness factor. The method can also comprise moving selected multimedia data from a first selected portion of the multimedia data to a second selected portion of the multimedia data, wherein the smoothness factor is adjusted.

In certain aspects, an apparatus is provided for processing multimedia data. The apparatus can comprise one or more of: a detector configured to detect a smoothness factor associated with one or more portions of the multimedia data, and to determine that smoothing is required based on the smoothness factor. The apparatus can also comprise an encoder configured to move selected multimedia data from a first selected portion of the multimedia data to a second selected portion of the multimedia data, wherein the smoothness factor is adjusted.

In certain aspects, an apparatus is provided for processing multimedia data. The apparatus can comprises one or more of: means for detecting a smoothness factor associated with one or more portions of the multimedia data, and means for determining that smoothing is required based on the smoothness factor. The apparatus can also comprise means for moving selected multimedia data from a first selected portion of the multimedia data to a second selected portion of the multimedia data, wherein the smoothness factor is adjusted.

In certain aspects, a machine readable medium is provided having instructions stored thereon, the stored instructions including one or more portions of code, and being executable on one or more machines. The one or more portions of code can comprise code for detecting a smoothness factor associated with one or more portions of the multimedia data. The one or more portions of code can also comprise code for determining that smoothing is required based on the smoothness factor. The one or more portions of code can also comprise code for moving selected multimedia data from a first selected portion of the multimedia data to a second selected portion of the multimedia data, wherein the smoothness factor is adjusted.

Other embodiments of the certain aspects will become apparent after review of the hereinafter set forth Brief Description of the Drawings, Description, and the Claims.

### BRIEF DESCRIPTION OF THE DRAWINGS

The foregoing aspects described herein will become more readily apparent by reference to the following Description when taken in conjunction with the accompanying drawings wherein:

FIG. 1 shows an exemplary network that comprises aspects of a smoothing system;

FIG. 2 shows exemplary smoothing logic for use in aspects of a smoothing system;

FIGS. 3A-D show examples that illustrate a smoothing processing in accordance with aspects of a smoothing system;

FIG. 4 shows an exemplary method for use in aspects of a smoothing system; and

FIG. 5 shows exemplary smoothing logic for use in aspects of a smoothing system.

### DESCRIPTION

In one or more aspects, a smoothing system is provided that operates to smooth a multimedia transmission over time and/or layers. In an aspect, the smoothing system detects a smoothness factor that indicates the burstiness and/or bit-rate variability associated with a multimedia transmission. If it is desirable to adjust the smoothness factor, the smoothing system operates to encode and/or move video frames of the multimedia transmission so as to adjust the smoothness factor. As a result, the processing burden on a receiving device that might be attempting to decode and render the content is reduced. The system is suited for use in wireless network environments, but may be used in any type of wired or wireless network environment, including but not limited to, communication networks, public networks, such as the Internet, private networks, such as virtual private networks (VPN), local area networks, wide area networks, long haul networks, or any other type of data network.

The following detailed description is directed to certain described aspects; however, the disclosure can be embodied in a multitude of different ways as defined and covered by the claims. In this description, reference is made to the drawings wherein like parts are designated with like numerals throughout.

### Introduction

In a content delivery/media distribution system, multimedia content is packed into transmission superframes and delivered to devices on a communication network. For example, the communication network may utilize Orthogonal Frequency Division Multiplexing (OFDM) to broadcast transmission superframes from a network server to one or more mobile devices. It should be noted that the distribution system is not limited to using OFDM technology and that other technologies such as code division multiple Access (CDMA), Time Division Multiple Access (TDMA), and transport control protocols such as TCP/IP may also be used.

The transmission superframes, which may comprise multiple sub-frames, might be configured to transmit a selected amount of multimedia data (e.g., a particular number of sub-frames, a certain amount of time, bandwidth utilization, and the like). For example, a transmission superframe may be configured to convey a plurality of multimedia channels and each channel can provide enough multimedia data to produce a multimedia presentation of selected time duration (i.e., one second) at a receiving device. Thus, a channel conveying a thirty second multimedia presentation may be transmitted using thirty transmission superframes.

Typically, the multimedia content comprises real time or near real time streaming video frames that generally need to be processed when received. Each of the video frames may be configured as one of several types of video frames having corresponding sizes. For example, one type of video frame is an independently decodable intra-coded frame (I-frame). An I-frame comprises all the data necessary to provide a complete video image and therefore may comprise a large amount of data. Other video frame types include temporally predicted P-frames or bi-directionally predicted B-frames that reference I-frames and/or other P-frames and/or B-frames. Because the P-frames and B-frames are not independently decodable (i.e., they reference other frames), they comprise less data and their sizes are typically smaller than I-frames. Additionally, communication networks may also facilitate multi-layer transmissions. For example, a transmission superframe may convey a base layer, for certain video frames, and one or more enhancement layers, for other video frames. Thus, the number of layers conveyed also contributes to the overall size of a transmission superframe.

During transmission of multimedia content each transmission superframe can be packed with enough video frames to produce a presentation of predetermined time duration at a receiving device. Thus, each transmission superframe includes some number of video frames comprising some combination of I, P, and B frame types. For example, a first transmission superframe may comprise I and P frame types, and a subsequent transmission superframe may comprise P and B frame types. As the transmission superframes are received, a receiving device operates to concatenate the received video frames into a video frame stream that is decoded to render a video presentation.

Multimedia processing systems may comprise video encoders that encode multimedia data using encoding methods based on international standards such as the Moving Picture Experts Group (MPEG)-1, -2 and -4 standards, the International Telecommunication Union (ITU)-T H.263 standard, and the ITU-T H.264 standard and its counterpart, ISO/IEC MPEG-4, Part 10, i.e., Advanced Video Coding (AVC), each of which is fully incorporated herein by reference for all purposes. Such encoding, and by extension, decoding, methods generally are directed to compressing the multimedia data for transmission and/or storage. Compression can be broadly thought of as the process of removing redundancy from the multimedia data.

A video signal may be described in terms of a sequence of pictures, which include frames (an entire picture), or fields (e.g., an interlaced video stream comprises fields of alternating odd or even lines of a picture). Further, each frame or field may further include two or more slices, or sub-portions of the frame or field. Video encoding methods compress video signals by using lossless or lossy compression algorithms to compress each frame. Intra-frame coding (also referred to herein as intra-coding) refers to encoding a frame using only that frame. Inter-frame coding (also referred to herein as inter-coding) refers to encoding a frame based on other, “reference,” frames. For example, video signals often exhibit temporal redundancy in which frames near each other in the temporal sequence of frames have at least portions that match or at least partially match each other.

Multimedia processors, such as video encoders, may encode a frame by partitioning it into a subset of pixels. These subsets of pixels may be referred to as blocks or macroblocks and may include, for example, macroblocks comprising an array of 16×16 pixels, or more or fewer pixels. The encoder may further partition each 16×16 macroblock into subblocks. Each subblock may further comprise additional subblocks. For example, subblocks of a 16×16 macroblock may include 16×8 and 8×16 subblocks. Each of the 16×8 and 8×16 subblocks may include, for example, 8×8 subblocks, which themselves may include, for example, 4×4, 4×2 and 2×4 subblocks, and so forth. The term “block” may refer to either a macroblock or any size of subblock.

Encoders can take advantage of temporal redundancy between sequential frames using inter-coding motion compensation based algorithms. Motion compensation algorithms identify portions of one or more reference frames that at least partially match a block. The block may be shifted in the frame relative to the matching portion of the reference frame(s). This shift is characterized by one or more motion vector(s). Any differences between the block and the partially matching portion of the reference frame(s) may be characterized in terms of one or more residual(s). The encoder may encode a frame as data that comprises one or more of the motion vectors and residuals for a particular partitioning of the frame. A particular partition of blocks for encoding a frame may be selected by approximately minimizing a cost function that, for example, balances encoding size with distortion, or perceived distortion, to the content of the frame resulting from an encoding.

Inter-coding enables more compression efficiency than intra-coding. However, inter-coding can create problems when reference data (e.g., reference frames or reference fields) are lost due to channel errors, and the like. In addition to loss of reference data due to errors, reference data may also be unavailable due to initial acquisition or reacquisition of the video signal at an inter-coded frame. In these cases, decoding of inter-coded data may not be possible or may result in undesired errors and/or error propagation. These scenarios can result, for example, in a loss of synchronization of the video stream.

An independently decodable intra-coded frame enables synchronization of the video signal. The MPEG-x and H.26× standards use what is known as a group of pictures (GOP) which comprises an I-frame and temporally predicted P-frames or bi-directionally predicted B-frames that reference the I-frame and/or other P and/or B frames within the GOP. Longer GOPs are desirable for the increased compression rates, but shorter GOPs allow for quicker acquisition and synchronization. Increasing the number of I-frames will permit quicker acquisition and synchronization, but at the expense of lower compression. Aspects of a smoothing system are described below. It should be noted that the smoothing system may utilize any of the encoding/decoding techniques, formats, and/or standards described above.

### Described Aspects

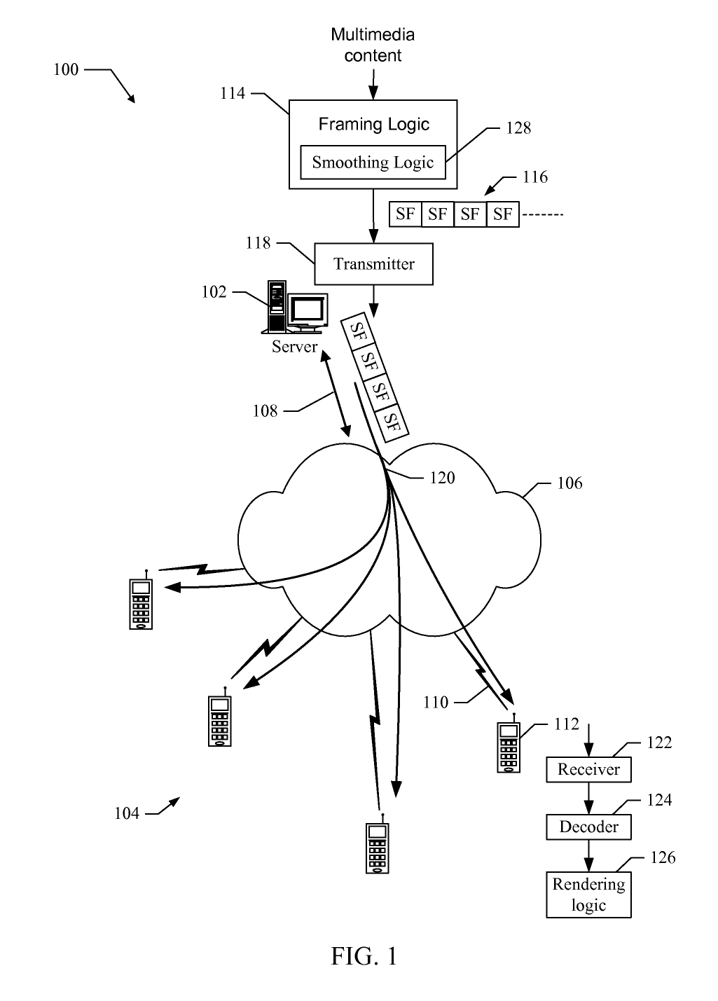

FIG. 1 shows an exemplary network 100 that comprises an aspect of a smoothing system. The network 100 comprises a server 102 that is in communication with a plurality of devices 104 utilizing a data network 106. In an aspect, the server 102 operates to communicate with the network 106 using any type of communication link 108. The network 106 may be any type of wired and/or wireless network, such as a network comprising OFDM, CDMA, TDMA, TCP/IP, and/or any other suitable technology. The network 106 communicates with the devices 104 using, for example, an OFDM link or any other suitable type of wireless communication link 110. The server 102 operates to transmit multimedia content to the devices 104. For the purpose of clarity, the operation of the network 100 is described below with reference to the device 112. However, the system is suitable for use with any of the devices 104.

In an aspect, the server 102 comprises framing logic 114 that operates to receive multimedia content for transmission over the network 106. For example, in an aspect, the multimedia content comprises a stream of video frames that comprise one or more of I, P, and B frames. In an aspect, the multimedia content may also comprise channel switch video (CSV) frames, which are low quality/resolution versions of I-frames and are configured to provide for fast channel acquisition and synchronization. The CSV frames are referred to hereinafter as C-frames.

In an aspect, the framing logic 114 operates to pack the multimedia content into a sequence of superframes (SF) that can represent, for example, a selected presentation time interval. Aspects can also include superframes that are defined by a certain number of video frames (and thus a variable time interval), as well as other SF-defining criteria. For example, in an aspect, each superframe contains enough data to produce a one second presentation of the multimedia content. Thus, the framing logic 114 operates with the goal of packing the stream of video frames representing the multimedia content into a sequence of superframes, as shown at 116. It should be noted that a superframe may comprise a plurality of channels and that the superframe is packed with multimedia data for each channel. However, for the purpose of clarity, only one channel is discussed herein, but aspects of the smoothing system are equally applicable for any number of channels in the superframe.

A transmitter 118 operates to receive the superframes and broadcast them over the network 106 as illustrated by the broadcast 120. The device 112 receives the broadcast 120 at a receiver 122. The receiver 122 demodulates the broadcast and the video frames contained in the superframes are passed to a decoder 124. The decoder 124 operates to decode the video frames, which are then rendered on the device 112 by rendering logic 126.

In an aspect, the server 102 comprises smoothing logic 128 that operates to detect a smoothness factor associated with the transmission superframes. For example, the smoothness factor may indicate that the superframes exhibit burstiness and/or bit-rate variability. The smoothness factor may also indicate any characteristic or condition of the transmission superframes, and base on that characteristic or condition, the smoothing process described herein can be performed.

In the case of burstiness, the smoothing logic 128 operates to smooth the bit-rate of the transmission superframes containing the multimedia content before transmission over the network 106. For example, a selected number of video frames are packed into each of the superframes 116. Depending on the type of video frames in each superframe, the overall bit-rate of each superframe may greatly vary resulting in undesirable burstiness.

In an aspect, the smoothing logic 128 operates to process the video frames across superframe boundaries (time) so as to smooth the bit-rate variability from superframe to superframe. For example, in an aspect, the smoothing logic 128 operates to select two or more superframes to be processed. In one of the superframes an I-frame is encoded at lower quality and therefore to comprise less data. Furthermore, a P-frame following the I-frame is encoded to have the data extracted from the I-frame. The encoded I-frame and P-frame are then positioned into different superframes. Thus, an I-frame, which usually comprises a large amount of data, can be encoded into a smaller “thinned” I-frame, or Iₜ-frame. The following P-frame, which usually comprises smaller amounts of data, can be encoded into a “fattened” P-frame, or P_{f}-frame, that can include data removed from the original I-frame. The thinned Iₜ-frame and fattened P_{f}-frames are located in different superframes, which may or may not be different from their original locations. As a result, the smoothness of the sequence of superframes is adjusted. For example, the overall bit-rate variability of the sequence of superframes is adjusted to have less variability.

The smoothing logic 128 operates to adjust the smoothness factor of the transmission superframes using several techniques wherein selected video frames are thinned, fattened, moved into different superframes, and/or moved between video layers. For example, any of the encoding techniques mention above and/or any other suitable encoding techniques may be used to encode the video frames as described. In another aspect, if a superframe is conveying multiple layers, the smoothing system operates to move video frames between layers to obtain a better balance between the layers.

In another aspect, the smoothing system does not operate to smooth the bit-rate variability from superframe to superframe, but instead operates to increase the bit-rate variability. For example, it may be desirable to have increased bit-rate variability between transmission superframes. In this case, the smoothing system operates to utilize similar encoding techniques to adjust the smoothness factor so as to increase the overall bit-rate and/or bit-rate variability of one or more transmission superframes.

A more detailed description of the operation of the smoothing logic 128 is provided in other sections of this document. It should be noted that the smoothing system illustrates in FIG. 1 is just one implementation and that other implementations are possible within the scope of the aspects.

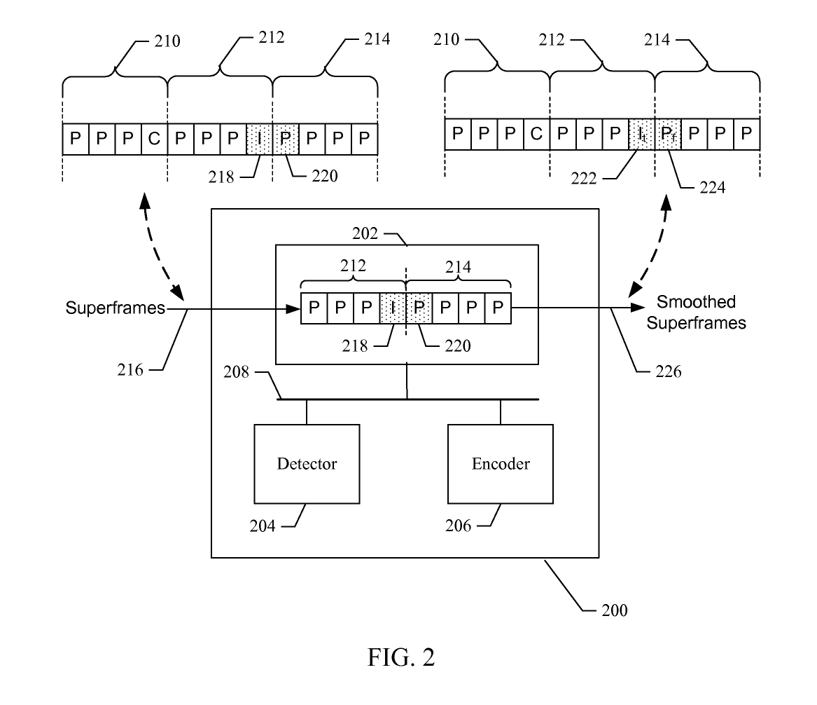

FIG. 2 shows exemplary smoothing logic 200 for use in aspects of a smoothing system. For example, the smoothing logic 200 is suitable for use as the smoothing logic 128 shown in FIG. 1. The smoothing logic 200 comprises a buffer 202, a detector 204, and an encoder 206 all coupled to a data bus 208. It should be understood that one or more of the buffer 202, detector 204, encoder 206 and/or data bus 208 may be combined and/or split into one or more physical and/or logical components.

The buffer 202 comprises any suitable memory or storage device operable to buffer one or more superframes that comprise multimedia video frames for transmission over a network. For example, in an aspect, superframes are generated by the framing logic 114 and input to the smoothing logic 200 as shown at 216. For example, the superframes 210, 212, and 214 are generated by the framing logic 114 and input to the smoothing logic 200. The buffer 202 is big enough to buffer (or store) any desired number of superframes. For example, in an aspect, the buffer 202 has the capacity to buffer ten superframes representing a ten second presentation of multimedia content. For the purpose of this description, only the superframes 212 and 214 are shown in the buffer 202, however, the buffer 202 may be configured to hold any number of superframes.

The superframes 212 and 214 are packed with video frames that may be in any format, including but not limited to, I-frames, P-frames, B-frames, C-frames and/or any other type of frame. For example, the superframes 212 and 214 are packed with four video frames each. The video frames stored in the buffer 202 are accessible by the detector 204 and encoder 206 through the data bus 208.

In an aspect, the detector 204 comprises one or more of a CPU, processor, gate array, hardware logic, memory elements, virtual machine, software, and/or any combination of hardware and software. The detector 204 operates to detect a smoothness factor associated with the buffered superframes. For example, in an aspect, the smoothness factor is determined from the amount of data in a superframe and/or from the difference in the data amounts from superframe to superframe. For example, the smoothness factor may indicate the burstiness (i.e., overall bit-rate and/or bit-rate variability) of the buffered superframes. In another aspect, the smoothness factor can indicate any other characteristic of the transmission superframes and the detector 204 can operate to determine that smoothing is required based on this or for any other purpose. Thus, the smoothing system can operate to perform the smoothing process for any purpose and/or to achieve any desired goal related to the transmission and rendering of the multimedia content.

In an aspect, the detector 204 operates to test the smoothness factor to determine if a superframe has a bit-rate that exceeds a selected threshold. For example, the detector 204 detects if the amount of video data included in a selected superframe exceed a pre-determined threshold. In another aspect, the detector 204 operates to test the smoothness factor to determine if the variation in bit-rate of consecutive superframes exceeds a selected threshold. For example, the detector 204 operates to process the superframes in the buffer 202 on a superframe by superframe basis. The bit-rate of each superframe is detected and if the variation in bit-rates exceeds a selected threshold (i.e., burstiness), the detector 204 notifies the encoder 206 and identifies those superframes associated with the detected burstiness.

In another aspect, the detector 204 detects a lack of burstiness based on the smoothness factor. For example, it may be desirable to have burstiness and/or high bit-rate variability associated with the transmission superframes. In this case, the detector 204 determines the smoothness factor and detects when the smoothness factor indicates a lack of burstiness and/or lack of high bit-rate variability. In this case, the detector 204 notifies the encoder 206 and identifies those superframes associated with the lack of burstiness so that the burstiness between superframes can be increased.

For the purpose of this description, it will be assumed that the detector 204 has detected that a smoothness factor associated with the superframe 212 has exceeded a desired threshold and/or range. For example, the superframe 212 has a high bit-rate in relation to the superframe 214, and as a result, a bit-rate variability threshold is exceeded. The detector 204 then notifies the encoder 206 regarding this condition and identifies the superframes 212 and 214.

In an aspect, the detector 204 operates to determine the sizes of one or more superframes in the buffer 202 to ascertain (i.e., check and/or verify) that adjacent superframes are of an appropriate size so that they can take on the extra data that may result in the smoothing process. If it is determined that adjacent superframes can take on more data, the detector 204 notifies the encoder 206 to continue with the smoothing process. For the purpose of this description, it will be assumed that the detector 204 has determined that the superframe 214 can take on additional data so that the smoothing process can continue.

In an aspect, the encoder 206 comprises one or more of a CPU, processor, gate array, hardware logic, memory elements, virtual machine, software, and/or any combination of hardware and software. In an aspect, the encoder 206 operates to encode I-frames so as to reduce their size to produce thinned Iₜ-frames. Saved bits from thinned I-frames will be used to encode following P-frames so as to increase their size and quality to produce fattened P_{f}-frames. By arranging the thinned Iₜ-frames and fattened P_{f}-frames to appear across superframe boundaries, the overall bit-rate of selected superframes can be smoothed over time.

As an example, it will be assumed that the detector 204 has detected the smoothness factor and has determined that the variation in bit-rate between the superframe 212 and the superframe 214 exceeds a selected threshold. The encoder 206 first determines that the superframe 212 includes the I-frame 218. In an aspect, the encoder 206 operates to thin the I-frame 218 and encode data from this I-frame into the P-frame 220. When the process is complete, the superframe 212 comprises the thinned Iₜ-frame 222 and the superframe 214 comprises the fattened P_{f}-frame 224. As a result, the bit-rate of the superframe 212 is reduced and the bit-rate of the superframe 214 is increased so as to provide bit-rate smoothing. The smoothed superframes are then output from the buffer 202 as shown at 226.

In another aspect, the encoder 206 can also operate to adjust the time boundaries of one or more superframes by moving frames from one superframe to another. For example, for the purpose of bit-rate smoothing, an Iₜ-frame (or a normal I-frame) may be moved to a subsequent superframe thereby increasing the total number of video frames in that superframe, which is effectively an adjustment to the time boundaries between superframes. In still another aspect, the encoder 206 operates to move video frames between layers being conveyed in a transmission superframe so as to better balance those layers.

Therefore, during operation the encoder 206 can operate to perform one or more of the following functions, alone or in any combination thereof, in aspects of a smoothing system.
1. Thin an I-frame to produce an Iₜ-frame.
2. Fatten a P-frame with quality refinement over a thinned I-frame to produce a P_{f}-frame.
3. Move Iₜ-frames (or I frames) from one superframe to another.
4. Move P_{f}-frames (or P frames) from one superframe to another.
5. Move C-frames from one superframe to another.
6. Move any type of frame between base and enhancement layers conveyed by a superframe.

In an aspect, the smoothing system comprises one or more program instructions (“instructions”) or one or more sets of “codes” stored on a machine-readable medium, which when executed by at least one machine, for instance, one or more processing machines at the smoothing logic 200, provides the functions described herein. For example, the sets of codes may be loaded into the smoothing logic 200 from a machine-readable medium, such as a floppy disk, CDROM, memory card, FLASH memory device, RAM, ROM, or any other type of memory device or machine-readable medium that interfaces to the smoothing logic 200. In another aspect, the sets of codes may be downloaded into the smoothing logic 200 from an external device or network resource. The sets of codes, when executed, provide aspects of a smoothing system as described herein.

### SMOOTHING EXAMPLES

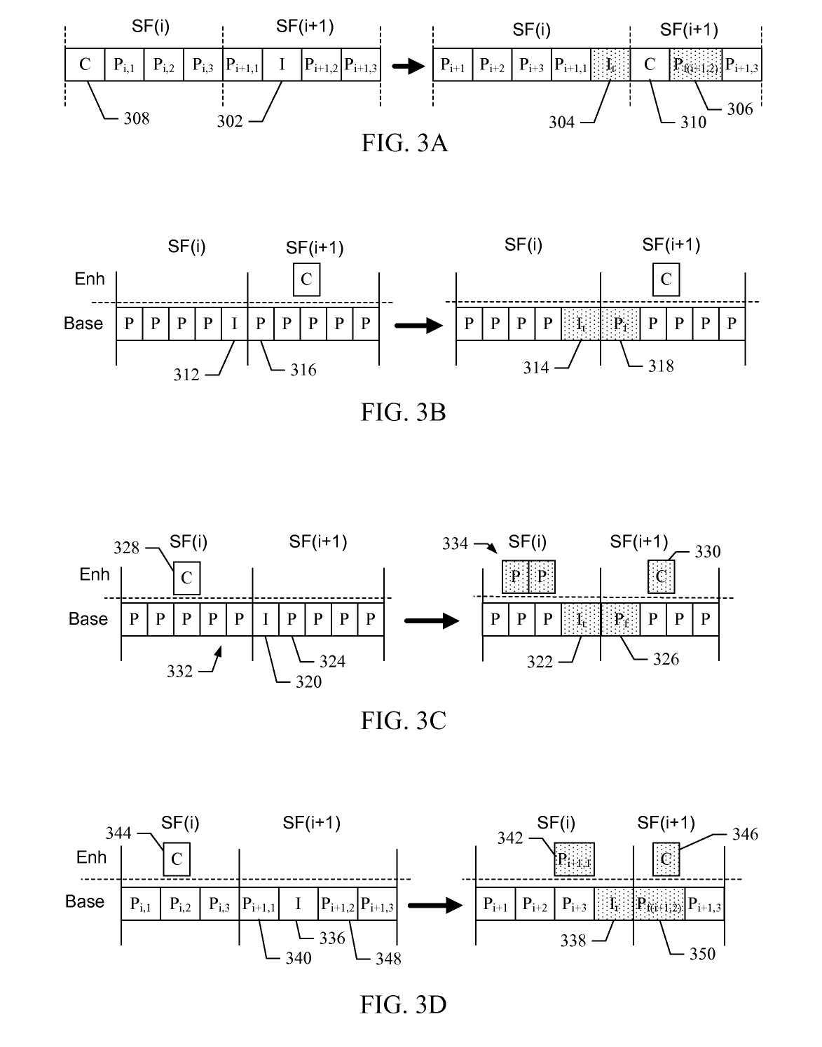

The following describes the exemplary operation of the smoothing logic 200 to provide bit-rate smoothing in four example situations. It should be noted that the smoothing system can be easily modified to provide aspects of bit-rate smoothing in a variety of situations and that the described situations are not to be construed so as to limit those various implementations. For example, it should be noted that the smoothing system can operate to provide smoothing based on overall bit-rate, bit-rate variability, and/or for any other reason. In the following examples described with reference to FIGS. 3A-D, shading is used to indicate a frame that has been processed or moved during operation of the smoothing system.

### Non-layered Mode

In a non-layered mode, aspects of the smoothing system provide for processing and/or moving frames across SF boundaries to temporally smooth bit-rate. Generally, any type of frame, such as I, B, P, C, etc., can be moved. In an aspect, the quality of two or more frames can be adjusted jointly, which may produce a better smoothing effect. Channel switching/acquisition can also be considered. For example, if there is a scene change provided by an I-frame in a SF, a redundant C-frame does not need to be sent in that SF. Therefore, when an I-frame is moved across a SF boundary, C-frames may also be moved, deleted and/or inserted to prevent redundancy, yet still facilitate appropriate channel switching/acquisition. In an aspect, the smoothing logic 200 is configured to perform the following functions.

FIG. 3A illustrates an example of bit-rate smoothing in a non-layered mode in accordance with aspects of a smoothing system. FIG. 3A shows two superframes, namely; SF(i) and SF(i+1), that exist in the input buffer 202. It will be assumed that the detector 204 has determined that the bit-rate of SF(i+1) exceeds a selected threshold, or that the variation in bit-rate between frames SF(i) and SF(i+1) exceeds a selected threshold and therefore has been determined to cause excessive burstiness. In order to reduce the size of SF(i+1) to smooth the bit-rate variation between SF(i) and SF(i+1), the encoder 206 operates as follows.

In SF(i+1) an I-frame 302 is thinned to produce the Iₜ-frame 304 that is moved to SF(i). Excess data is incorporated into a fattened P_{f}-frame (P_{f(i+1,2}) 306 that remains in SF(i+1). Since moving the Iₜ-frame 304 resulted in SF(i+1) having no independently decodable frame, the C-frame 308 can be removed from SF(i) and a C-frame can be inserted in SF(i+1), as is shown as the C-frame 310.

### Layered Modes

In an aspect, the smoothing system operates to reduce burstiness related to the total bit rate of video frames comprising a base layer plus one or more enhancement layers. In another aspect, the enhancement layer(s) can be used to transport various frame types to allow bit-rate balancing between the base and the enhancement layer(s).

For the purpose of balancing the base and enhancement layers, B-frames can be sent either through the base layer or the enhancement layer. In certain circumstances, I-frames, P-frames, and C-frames may be put in the enhancement layer. Thus, whether to send frames in the base or the enhancement layer may depend on the bit-rate balance between the base and enhancement layers. For simplicity, B-frames which could be located in the base and the enhancement layers in FIGS. 3B-D are not shown, and the real number of I and P frames could be more than what is shown in those figures. In an aspect, the smoothing logic 200 is configured to perform the following functions.

FIG. 3B illustrates an example of bit-rate smoothing in a layered mode in accordance with aspects of a smoothing system. FIG. 3B shows two superframes, namely; SF(i) and SF(i+1), and also shows base (Base) and enhancement (Enh) layers conveyed by those superframes. It will be assumed that the superframes SF(i) and SF(i+1) exist in the input buffer 202. It will further be assumed that the detector 204 has determined that the bit-rate of SF(i) exceeds a selected threshold or that the variation in bit-rate between SF(i) and SF(i+1) exceeds a selected threshold and therefore has been determined to cause excessive burstiness or that the I-frame 312 in SF(i) makes it difficult to balance the two layers in SF(i). In order to reduce the size of SF(i) to get better balance, the encoder 206 operates as follows.

A scene change is indicated by an I-frame 312 shown at the end of SF(i), which causes burstiness in the base layer. In an aspect, the smoothing system operates to thin the I-frame 312 and the resulting Iₜ-frame 314 reduces the bit-rate of the base layer of SF(i). A P-frame 316 that follows the I-frame 312 is also encoded to produce a fattened P_{f}-frame 318 in SF(i+1) to recover the quality lost as a result of thinning the I-frame 312. For simplicity, a C-frame is provided only in the enhancement layer of SF(i+1).

FIG. 3C illustrates an example of bit-rate smoothing in a layered mode in accordance with aspects of a smoothing system. FIG. 3C shows two superframes, namely; SF(i) and SF(i+1) and also shows base (Base) and enhancement (Enh) layers conveyed by those superframes. It will be assumed that the superframes SF(i) and SF(i+1) exist in the input buffer 202. It will be assumed that the detector 204 has determined that the bit-rate of SF(i+1) exceeds a selected threshold or that the variation in bit-rate between SF(i) and SF(i+1) exceeds a selected threshold and therefore has been determined to cause excessive burstiness or that the I-frame 320 in SF(i+1) makes it difficult to balance the two layers in SF(i+1). In order to reduce the size of SF(i+1) to get better balance, the encoder 206 operates as follows.

A scene change is represented by an I-frame 320 at the beginning of the SF(i+1). The I-frame 320 is encoded at a lower quality to form a thinned Iₜ-frame 322 that is moved to the superframe SF(i). A P-frame 324 is fatten with data from the thinned Iₜ-frame to produce the P_{f}-frame 326. Because the Iₜ-frame 322 can be used for acquisition and synchronization there is no need to have a redundant C-frame 328 in SF(i), and so it is removed from SF(i), and C-frame 330 is inserted into SF(i+1) to allow acquisition of SF(i+1). For better balancing in SF(i), the last two P-frames in SF(i) shown at 322 are moved to the enhancement layer as shown at 334.

FIG. 3D illustrates an example of bit-rate smoothing in a layered mode in accordance with aspects of a smoothing system. FIG. 3D shows two superframes, namely; SF(i) and SF(i+1) and also shows base (Base) and enhancement (Enh) layers conveyed by those superframes. It will be assumed that the superframes SF(i) and SF(i+1) exist in the input buffer 202. It will be assumed that the detector 204 has determined that the bit-rate of SF(i+1) exceeds a selected threshold or that the variation in bit-rate between SF(i) and SF(i+1) exceeds a selected threshold and therefore has been determined to cause excessive burstiness or that the I-frame 336 in SF(i+1) makes it difficult to balance the two layers in SF(i+1). In order to reduce the size of SF(i+1) to get better balance, the encoder 206 operates as follows.

With an I-frame 336 in the middle of the SF(i+1) as shown, either of the previous two methods can be performed to provide bit-rate smoothing. If the second method is performed, the I-frame 336 is thinned to form the thinned Iₜ-frame 338, which is moved to SF(i). A P-frame 340 in front of the I-frame 336 is also moved to SF(i), as shown at 342. The P-frame 340 could be located in either the base layer or the enhancement layer, and in this example, is shown in the enhancement layer to improve the balance of SF(i). To allow acquisition in SF(i+1), a C-frame 344 located in SF(i) is removed and C-frame 346 is inserted in into SF(i+1). A P-frame 348 associated with I-frame 336 is fattened to produce the fattened P_{f}-frame 350.

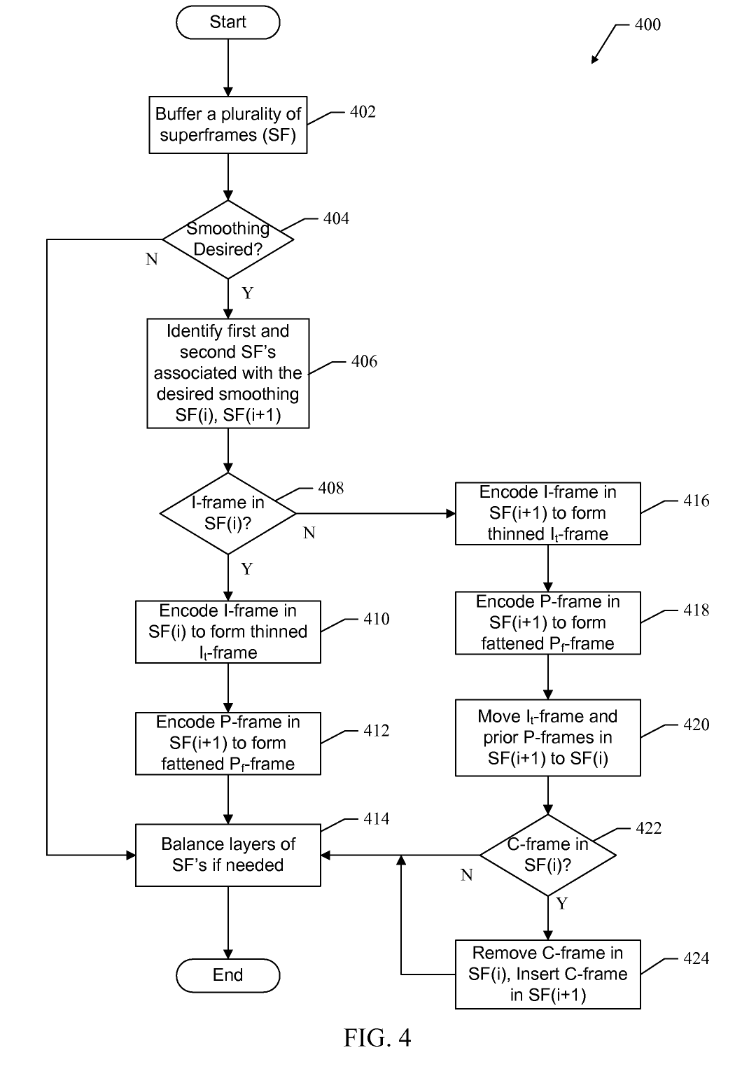

FIG. 4 shows an exemplary method 400 for use in aspects of a smoothing system. For clarity, the method 400 is described herein with reference to the smoothing logic 200 shown in FIG. 2. For example, in an aspect, the smoothing logic 200 executes one or more sets of codes or instructions on one or more processing machines to perform the functions, in total, or selectively combined, reduced and/or re-ordered, described below.

At block 402, one or more superframes are buffered. In an aspect, superframes comprising multimedia content are received from the framing logic 114 and buffered in the buffer 202.

At block 404, a determination is made as to whether smoothing is desired with regards to the buffered superframes. In an aspect, the detector 204 operates to determine and test a smoothness factor that indicators whether smoothing is desired. For example, the smoothness factor may indicate undesirable burstiness if the bit-rate of a selected superframe exceeds a selected threshold. In another aspect, smoothness factor may indicate undesirable burstiness if the variation in bit-rate between superframes exceeds a selected threshold. In an aspect, the detector 204 operates to detect burstiness or any unbalance in the buffered superframes. It should be noted that the detector 204 can operate to determine that smoothing is desired for any reason or purpose. If smoothing is not desired, the method proceeds to block 414. If smoothing is desired, the method proceeds to block 406.

At block 406, first and second superframes (SF(i) and SF(i+1)) are identified that are associated with the desired smoothing. For example, the detector 204 operates to determine two superframes between which the bit-rate experiences a large variation. The identity of the superframes is passed to the encoder 206.

At block 408, a determination is made as to whether there is an I-frame in the first identified superframe SF(i). For example, the encoder 206 makes this determination. If there is an I-frame, the method proceeds to block 410. If there is not an I-frame in the first identified superframe SF(i), the method proceeds to block 416.

At block 410, The I-frame in the first identified superframe SF(i) is encoded to produce a thinned Iₜ-frame. For example, the encoder 206 operates to encode the I-frame so as to reduce its resolution and/or quality to produce the thinned Iₜ-frame.

At block 412, a P-frame in the second superframe is encoded to form a fattened P_{f}-frame. For example, the encoder 206 operates to encode a selected P-frame in the second identified superframe SF(i+1) so that data removed to produce the thinned Iₜ-frame is encoded into the P-frame to produce the fattened P_{f}-frame. As a result, the first identified superframe SF(i) experiences a reduction in size (and therefore bit-rate) and the second identified superframe SF(i+1) experiences an increase in size (and therefore bit-rate), which reduces the detected burstiness associated with the superframes.

At block 416, it has been determined that an I-frame is located in the second identified superframe SF(i+1) and that I-frame is thinned to produce a thinned Iₜ-frame. For example, the encoder 206 operates to encode the I-frame to produce the thinned Iₜ-frame.

At block 418, a P-frame subsequent to the thinned Iₜ-frame is encoded to produce a fattened P_{f}-frame. In an aspect, the encoder 206 operates to encode the P_{f}-frame with data derived from the Iₜ-frame.

At block 420, the Iₜ-frame and any prior P-frames in the second identified superframe SF(i+1) are moved to the first identified superframe SF(i). For example the encoder 206 operates to move the Iₜ-frame and any prior P-frames in the SF(i+1) to the first identified superframe SF(i). This is illustrated in FIG. 3D.

At block 422, a determination is made as to whether there is a C-frame in the first identified superframe SF(i). In an aspect, the encoder 206 makes this determination. If there is no C-frame in the first superframe SF(i), the method proceeds to block 414. If there is a C-frame in the first superframe SF(i), the method proceeds to block 424.

At block 424, the C-frame in the first identified superframe SF(i) is removed and a C-frame is inserted in the second identified superframe SF(i+1). In an aspect, the encoder 206 performs this function. For example, the C-frame 344 shown in the first superframe SF(i) in FIG. 3D is removed and C-frame 346 is inserted in the second superframe SF(i+1).

At block 414, the layers of one or more superframes are balanced if needed. In an aspect, encoder 206 operates to balance the base and enhancement layers of one or more superframes. For example, after encoding and moving of frames between superframes, it may be desirable to balance the size of the base and enhancement layers by moving frames from the base layer to the enhancement layer or vice versa.

Thus, the method 400 operates to provide an aspect of a smoothing system. It should be noted that the method 400 represents just one implementation and that other implementations are possible within the scope of the aspects.

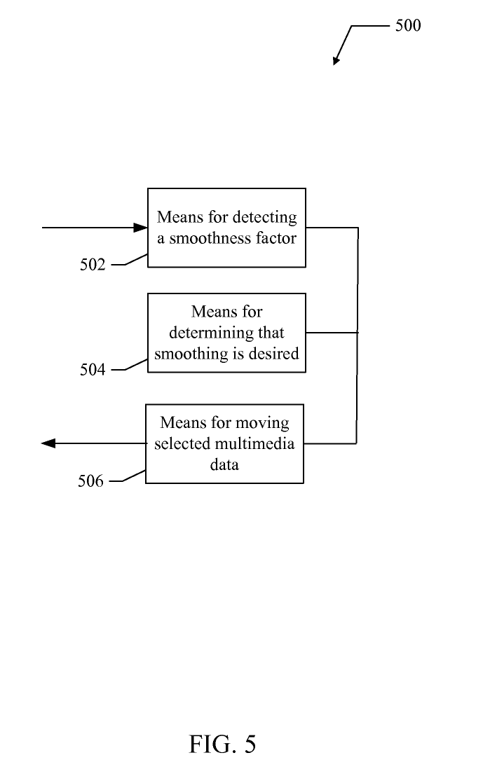

FIG. 5 shows exemplary smoothing logic 500 for use in aspects of a smoothing system. For example, the smoothing logic 500 is suitable for use as the smoothing logic 102 shown in FIG. 1. In an aspect, the smoothing logic 500 is implemented by at least one processor comprising one or more modules configured to execute one or more sets of codes to provide aspects of a smoothing system as described herein. For example, each module comprises hardware, software, or any combination thereof.

The smoothing logic 500 comprises a first module 502 comprising means for detecting a smoothness factor, which in an aspect comprises the detector 204. The smoothing logic 500 also comprises a second module 504 comprising means for determining that smoothing is desired, which in an aspect comprises the detector 204. The smoothing logic 500 also comprises a third module 506 comprising means for moving selected multimedia data, which in an aspect comprises the encoder 206. It should be noted that the smoothing logic 500 represents just one implementation and that other implementations are possible within the scope of the aspects.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The description of the disclosed aspects is provided to enable any person skilled in the art to make or use the present invention. Various modifications to these aspects may be readily apparent to those skilled in the art, and the generic principles defined herein may be applied to other aspects, e.g., in an instant messaging service or any general wireless data communication applications, without departing from the spirit or scope of the invention. Thus, the present invention is not intended to be limited to the aspects shown herein but is to be accorded the widest scope consistent with the principles and novel features disclosed herein. The word “exemplary” is used exclusively herein to mean “serving as an example, instance, or illustration.” Any aspect described herein as “exemplary” is not necessarily to be construed as preferred or advantageous over other aspects.

Accordingly, while aspects of a smoothing system have been illustrated and described herein, it will be appreciated that various changes can be made to the aspects without departing from their spirit or essential characteristics. Therefore, the disclosures and descriptions herein are intended to be illustrative, but not limiting, of the scope of the invention, which is set forth in the following claims.

What is claimed is:

1. A method for processing multimedia data, the method comprising:
detecting a smoothness factor associated with one or more portions of the multimedia data;
determining that smoothing is required based on the smoothness factor; and
moving selected multimedia data from a first selected portion of the multimedia data to a second selected portion of the multimedia data, wherein the smoothness factor is adjusted.

2. The method of claim 1, wherein said detecting comprises detecting when a bit-rate associated with at least one portion of the multimedia data exceeds a selected threshold.

3. The method of claim 1, wherein said detecting comprises detecting when a bit-rate associated with at least one portion of the multimedia data falls below a selected threshold.

4. The method of claim 1, wherein said detecting comprises detecting when a bit-rate variation between at least two portions of the multimedia data exceeds a selected threshold.

5. The method of claim 1, wherein said moving comprises adjusting a time duration associated with at least one of the first selected portion and the second selected portion of multimedia data.

6. The method of claim 1, wherein said moving comprises moving data associated with one or more video frames between the first selected portion and the second selected portion of multimedia data.

7. The method of claim 1, wherein said moving comprises moving data associated with one or more video frames across at least one of a time boundary and a layer boundary associated with the one or more portions.

8. The method of claim 1, wherein said moving comprises:
encoding a first video frame so that a first video frame size is reduced to produce a thinned video frame wherein selected data is removed; and
encoding a second video frame to include the selected data so that a second video frame size is increased to produce a fattened frame.

9. The method of claim 8, wherein said moving comprises moving at least one of the thinned frame and the fattened frame across at least one of a time boundary and a layer boundary associated with the one or more portions.

10. The method of claim 1, further comprising balancing a base layer size and an enhancement layer size associated with the at least one or more portions.

11. An apparatus for processing multimedia data, the apparatus comprising:
a detector configured to detect a smoothness factor associated with one or more portions of the multimedia data, and to determine that smoothing is required based on the smoothness factor; and
an encoder configured to move selected multimedia data from a first selected portion of the multimedia data to a second selected portion of the multimedia data, wherein the smoothness factor is adjusted.

12. The apparatus of claim 11, wherein said detector is configured to detect when a bit-rate associated with at least one portion of the multimedia data exceeds a selected threshold.

13. The apparatus of claim 11, wherein said detector is configured to detect when a bit-rate associated with at least one portion of the multimedia data falls below a selected threshold.

14. The apparatus of claim 11, wherein said detector is configured to detect when a bit-rate variation between at least two portions of the multimedia data exceeds a selected threshold.

15. The apparatus of claim 11, wherein said encoder is configured to adjust a time duration associated with at least one of the first selected portion and the second selected portion of multimedia data.

16. The apparatus of claim 11, wherein said encoder is configured to move data associated with one or more video frames between the first selected portion and the second selected portion of multimedia data.

17. The apparatus of claim 11, wherein said encoder is configured to move data associated with one or more video frames across at least one of a time boundary and a layer boundary associated with the one or more portions.

18. The apparatus of claim 11, wherein said encoder is configured to:
encode a first video frame so that a first video frame size is reduced to produce a thinned video frame wherein selected data is removed; and
encode a second video frame to include the selected data so that a second video frame size is increased to produce a fattened frame.

19. The apparatus of claim 18, wherein said encoder is configured to move at least one of the thinned frame and the fattened frame across at least one of a time boundary and a layer boundary associated with the one or more portions.

20. The apparatus of claim 11, wherein said encoder is configured to balance a base layer size and an enhancement layer size associated with the at least one or more portions.

21. An apparatus for processing multimedia data, the apparatus comprising:
means for detecting a smoothness factor associated with one or more portions of the multimedia data;
means for determining that smoothing is required based on the smoothness factor; and
means for moving selected multimedia data from a first selected portion of the multimedia data to a second selected portion of the multimedia data, wherein the smoothness factor is adjusted.

22. The apparatus of claim 21, wherein said means for detecting comprises means for detecting when a bit-rate associated with at least one portion of the multimedia data exceeds a selected threshold.

23. The apparatus of claim 21, wherein said means for detecting comprises means for detecting when a bit-rate associated with at least one portion of the multimedia data falls below a selected threshold.

24. The apparatus of claim 21, wherein said means for detecting comprises means for detecting when a bit-rate variation between at least two portions of the multimedia data exceeds a selected threshold.

25. The apparatus of claim 21, wherein said means for moving comprises means for adjusting a time duration associated with at least one of the first selected portion and the second selected portion of multimedia data.

26. The apparatus of claim 21, wherein said means for moving comprises means for moving data associated with one or more video frames between the first selected portion and the second selected portion of multimedia data.

27. The apparatus of claim 21, wherein said means for moving comprises means for moving data associated with one or more video frames across at least one of a time boundary and a layer boundary associated with the one or more portions.

28. The apparatus of claim 21, wherein said means for moving comprises:
means for encoding a first video frame so that a first video frame size is reduced to produce a thinned video frame wherein selected data is removed; and
means for encoding a second video frame to include the selected data so that a second video frame size is increased to produce a fattened frame.

29. The apparatus of claim 28, wherein said means for moving comprises means for moving at least one of the thinned frame and the fattened frame across at least one of a time boundary and a layer boundary associated with the one or more portions.

30. The apparatus of claim 21, further comprising means for balancing a base layer size and an enhancement layer size associated with the at least one or more portions.

31. A machine readable medium having instructions stored thereon, the stored instructions including one or more portions of code, and being executable on one or more machines, the one or more portions of code comprising:
code for detecting a smoothness factor associated with one or more portions of the multimedia data;
code for determining that smoothing is required based on the smoothness factor; and
code for moving selected multimedia data from a first selected portion of the multimedia data to a second selected portion of the multimedia data, wherein the smoothness factor is adjusted.

32. The machine readable medium of claim 31, wherein said detecting comprises detecting when a bit-rate associated with at least one portion of the multimedia data exceeds a selected threshold.

33. The machine readable medium of claim 31, wherein said code for detecting comprises code for detecting when a bit-rate associated with at least one portion of the multimedia data falls below a selected threshold.

34. The machine readable medium of claim 31, wherein said code for detecting comprises code for detecting when a bit-rate variation between at least two portions of the multimedia data exceeds a selected threshold.

35. The machine readable medium of claim 31, wherein said code for moving comprises code for adjusting a time duration associated with at least one of the first selected portion and the second selected portion of multimedia data.

36. The machine readable medium of claim 31, wherein said code for moving comprises code for moving data associated with one or more video frames between the first selected portion and the second selected portion of multimedia data.

37. The machine readable medium of claim 31, wherein said code for moving comprises code for moving data associated with one or more video frames across at least one of a time boundary and a layer boundary associated with the one or more portions.

38. The machine readable medium of claim 31, wherein said code for moving comprises:
code for encoding a first video frame so that a first video frame size is reduced to produce a thinned video frame wherein selected data is removed; and
code for encoding a second video frame to include the selected data so that a second video frame size is increased to produce a fattened frame.

39. The machine readable medium of claim 38, wherein said code for moving comprises code for moving at least one of the thinned frame and the fattened frame across at least one of a time boundary and a layer boundary associated with the one or more portions.

40. The machine readable medium of claim 31, further comprising code for balancing a base layer size and an enhancement layer size associated with the at least one or more portions.
